(19) United States
(12) Patent Application Publication
(10) Pub. No.: US 2016/0001984 A1
(43) Pub. Date: Jan. 7, 2016

(54) DEVICE FOR THE GAPLESS TRANSFER OF UNFILLED TUBES TO A CONVEYOR BELT

(71) Applicant: Texa AG, Haldenstein (CH)

(72) Inventor: Gottlieb BENZ, Flums (CH)

(21) Appl. No.: 14/789,846

(22) Filed: Jul. 1, 2015

(30) Foreign Application Priority Data
Jul. 2, 2014 (CH) 01006/14

(51) Int. Cl. B65G 47/57; B65G 21/20; B65G 37/00

(52) U.S. Cl. CPC B65G 47/57; B65G 37/00; B65G 21/2036

(57) ABSTRACT

In a transfer device for the transfer of thin-walled tubes to a transport device comprising a continuously conveying supply device for the individual supply of product units supplied from a production line, and a transport device with a conveyor belt that comprises a multitude of product receiving elements; it is provided that the supply device comprises a transfer control unit that is configured in such a manner that it matches the speed of the conveyor belt to a predetermined conveyance speed of the supply device so that a product unit to be transferred, having been delivered at the end of the product guide, lands precisely on the first free product receiving element in the direction of conveyance; and that the transfer device comprises a suction device for producing a suction vacuum, wherein for the transfer of a product unit, which has been supplied by the supply device, to the conveyor belt several product receiving elements that are situated in the transfer region of the transfer device can be operated with the suction vacuum of the suction device so that the product unit to be transferred is held and stabilized in the transfer region in the product receiving element by means of the suction vacuum both during landing and during onwards transfer.

### REFERENCE TO RELATED APPLICATIONS

This application claims priority to Swiss patent application no. CH-01006/14, filed Jul. 2, 2014.

### TECHNICAL FIELD

The present invention relates to a transfer device for the gapless transfer of elongated, at least approximately hollow cylindrical, product units, namely thin-walled unfilled tubes, to a conveyor belt of a packaging machine.

### BACKGROUND TO THE INVENTION

Devices that are used to group product units into product groups and to package them into boxes are known in many embodiments. The method-related procedure and a corresponding device to implement such a method in each case strongly depend on the type of product units. In particular, thin-walled unfilled tubes are very sensitive to pressure, which requires the conveyance of single product units, thus limiting the options for efficient transfer. Not even the slightest deformation is tolerable. For this reason it is not possible to use, for example, methods involving streams where product units bank up, or methods in which the product units, either randomly oriented or uniformly oriented, are placed on top of each other in reservoirs.

The present invention relates to the field of conveying and packaging elongated, at least approximately hollow cylindrical, product units, namely thin-walled unfilled tubes as described, for example, in EP1114784. In particular, the invention relates to the transfer of such product units, which are supplied by a production line, to a conveyor belt of a packaging machine. For packaging, the product units need to be placed on the conveyor belt without there being any gaps, so that product groups can then be formed.

In EP1114784 product units that arrive from a production line are placed into conveyance pods. In these conveyance pods the product units are conveyed, by means of a conveyor unit, in the region of a transfer path. In this region the conveyance pods are tipped over, and the product units are placed on a placement surface that varies in length or size. By means of a movable catch, the placement surface is moved back with a jerk so that the product units fall into product receiving devices of a conveyor belt. Once a product group has been fully formed, it is conveyed to the removal position and the next product group is formed. During transfer of the product units for a product group the conveyor belt is at a standstill.

EP1394081 describes quite a complicated device for accepting cartridges or tubes from a production line which, because of rejects, has a discontinuous output of tubes or cartridges. However, the subsequent packaging machine requires a continuous and gapless supply of the cartridges or tubes. The device of EP1394081 comprises a chain conveyor with a conveyance path. The conveyance path, which overlaps the corresponding transfer paths of the production machine or of the packaging machine, is mounted on a carriage and can be moved to and fro in the direction of conveyance. As a result of this, the chain conveyor at the moment of transfer of the tubes or cartridges from the production machine to the acceptance device appears to be at a standstill.

In the device according to EP0594917, step by step, on a conveyor movable slides with product receiving devices are loaded at a transfer position. At the transfer position the transfer path of the supplying conveyor and of the slide conveyor is inclined upwards in the direction of conveyance. The supplied product units are guided along a product guide, arranged between the conveyors, in the form of a guide plate, and at the end of the guide plate are transferred to product receiving devices of the incrementally forwards-moving slide. The transfer device known from EP0774414 operates in a similar manner, wherein, however, the two conveyors are not aligned parallel to each other in the transfer region.

### SUMMARY

It has been shown that in the known transfer devices, in particular for light plastic tubes or aluminium tubes, the maximum transfer speeds are severely limited. The usual transfer speeds or transfer rates are around 150 units per minute. At higher transfer speeds of 200 units per minute or above, during transfer the tubes tend to jump from the product receiving devices. This effect can be significantly increased, in particular, by possible electrostatic charges in the case of plastic tubes. Furthermore, with very high transfer speeds or transfer rates of approximately 300 tubes per minute or more, rolling-off by way of a guide plate is practically no longer possible, and the tubes then need to be transferred in “free flight” or “flying” to the product receiving device.

It is an object of the invention to state a transfer device for the gapless “flying” transfer of elongated, at least approximately hollow cylindrical, product units, in the form of thin-walled tubes, to a transport device for supplying a packaging unit with product units that are arranged side by side without any gaps, by means of which transfer device the transfer speed can be significantly increased when compared to that of known devices.

The transfer device for the transfer of elongated, at least approximately hollow cylindrical, product units in the form of thin-walled tubes to a transport device for supplying a packaging unit with product units that are arranged side by side without any gaps comprises a supply device which conveys at a predetermined, usually constant, speed, for the supply of product units arriving from a production line, and a transport device with a conveyor belt that comprises a multitude of product receiving elements for the onward conveyance of the product units. The supply device comprises an endless conveyor chain with a multitude of product receiving containers for accommodating individual product units supplied from the production line. The conveyor chain of the supply device and the conveyor belt of the transport device extend in a transfer region in the same direction of conveyance, gradually rising and parallel to each other at some distance. Underneath the conveyor chain a product guide is arranged whose one end extends to the transfer region. The transfer device further comprises a transfer control unit that is configured in such a manner that it matches the speed of the conveyor belt to a predetermined conveyance speed of the supply device so that a product unit to be transferred, having been delivered at the end of the product guide, lands precisely on the first free product receiving element in the direction of conveyance. The transfer device further comprises a suction device for producing a suction vacuum, wherein for the transfer of a product unit, which has been supplied by the supply device, to the conveyor belt several product receiving elements that are situated in the transfer region of the transfer device can be operated with the suction vacuum of the suction device so that the product unit to be transferred is held and stabilised in the transfer region in the product receiving element by means of the suction vacuum both during landing and during onwards transfer.

The transfer region defines a region that extends over several product receiving elements that are operated with suction vacuum, wherein the effective transfer of the product unit to the conveyor belt, i.e. the position of the respective product receiving element in the transfer region during pickup of a product unit, depends on the transfer rate or on the supply speed of the supply device. In the case of low transfer rates or low supply speeds the effective transfer takes place at the beginning of the transfer region, and there would not be a need to provide a suction vacuum because a product unit can be delivered in a positionally accurate and reliable manner, by way of a roll-off region at the end of the product guide, to a product receiving element. However, in the case of very high transfer rates of more than 300 product units per minute, such rolling-off is no longer possible. The product units are then delivered in “free flight” to a product receiving element. In this case, i.e. in the case of a “flying” transfer, precise control of the speed depending on the supply speed and on the flight trajectory of the product unit (path from delivery at the end of the product guide to receipt in the product receiving element) is necessary. Furthermore, a suction vacuum is necessary in order to ensure precise landing of the product unit to be transferred, and in order to prevent any “jumping out”. By means of the transfer device according to the invention the transfer rate can thus be significantly increased.

While from many transfer devices for other types of product units, e.g. cigarettes, suction devices for generating a suction vacuum are known, these devices are, however, not used for the removal and onward-conveyance of product units from a reservoir where product units bank up. Such an application of the suction vacuum is, for example, known from the processing or packaging of cigarettes (compare U.S. Pat. No. 3,262,243). As already mentioned above, such methods involving streams where product units bank up are, however, not suitable for tubes that are sensitive to pressure.

In some embodiments the transfer device can comprise a product unit detector, arranged on the supply device in the direction of conveyance upstream of the transfer region, in order to detect the presence of a product unit in a product receiving container. Furthermore, the product unit detector is connected to the transfer control unit in order to, in the case of the non-presence of a product unit, reduce the speed of the conveyor belt until the next product unit is delivered. If the there are gaps in the supply stream as a result of rejected faulty product units, said gaps are detected by the product unit detector, and the conveyance speed of the conveyor belt can be reduced or stopped until the next product unit is supplied in order to, in this manner, ensure a gapless transfer to the conveyor belt even in the case of irregular supply.

In some embodiments the product receiving elements of the conveyor belt can each comprise at least one suction intake opening that can be operated with the suction vacuum of the suction device. Preferably, several suction intake openings are arranged essentially in the middle along the product receiving element.

In some embodiments the conveyor belt can comprise two spaced-apart endless belts to which the product receiving elements are attached, wherein the suction intake openings of the product receiving elements are arranged above the gap between the two endless belts.

In some embodiments the suction device can comprise at least one suction opening arranged along the transfer region, by means of which suction opening the at least one suction intake opening or the several suction intake openings of the product receiving element situated in the transfer region can be operated with a suction vacuum. The at least one suction opening of the suction device can be arranged in the transfer region between the two endless belts of the conveyor belt.

During operation of the transfer device the product receiving elements in the transfer region with their suction intake openings are moved over the suction opening of the suction device, and in this process are operated with the suction vacuum until they leave the transfer region in the direction of conveyance. In other words, during the actual transfer of the product unit the receiving elements are always operated with suction vacuum, independently of their position in the transfer region.

In some embodiments the product guide at the end can comprise a roll-off region adjacent to the product guide and inclined towards the conveyor belt in order to, at slow transfer rates, make it possible for the product unit to roll off into the corresponding product receiving device. Such a transfer device can then, depending on requirements, be operated either at high transfer rates or at low transfer rates, which is useful, in particular, at the time of start-up of the device.

The conveyor chain and the conveyor belt can be belts or chains comprising receiving devices or containers. Purely to provide better understanding, in the present invention two different terms are used. The receiving devices or containers need to match the diameters of the tubes, and correspondingly the conveyor chains or conveyor belts with containers or receiving devices attached thereto are altogether exchangeable.

### BRIEF DESCRIPTION OF THE FIGURES

The invention is explained in more detail below with reference to exemplary embodiments in conjunction with the drawings, wherein:

FIG. 1 shows a perspective view of a section of a transfer device;

FIG. 2 shows a perspective view of a section of the transfer device of FIG. 1;

FIG. 3 shows a lateral view of the transfer region of the transfer device of FIG. 1;

FIG. 4 shows a perspective view of the suction device of the transfer device of FIG. 1; and

FIG. 5 shows a perspective view of the conveyor belt and of the suction device of the transfer device of FIG. 1 without the supply device.

### DETAILED DESCRIPTION

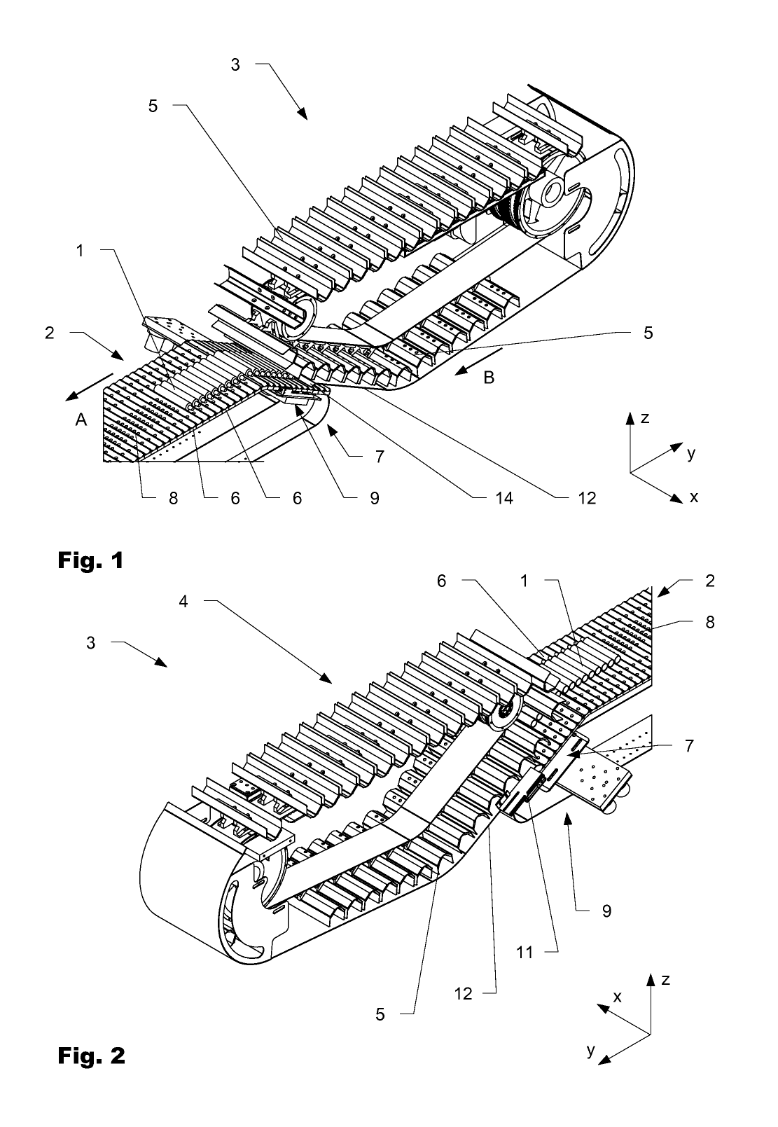

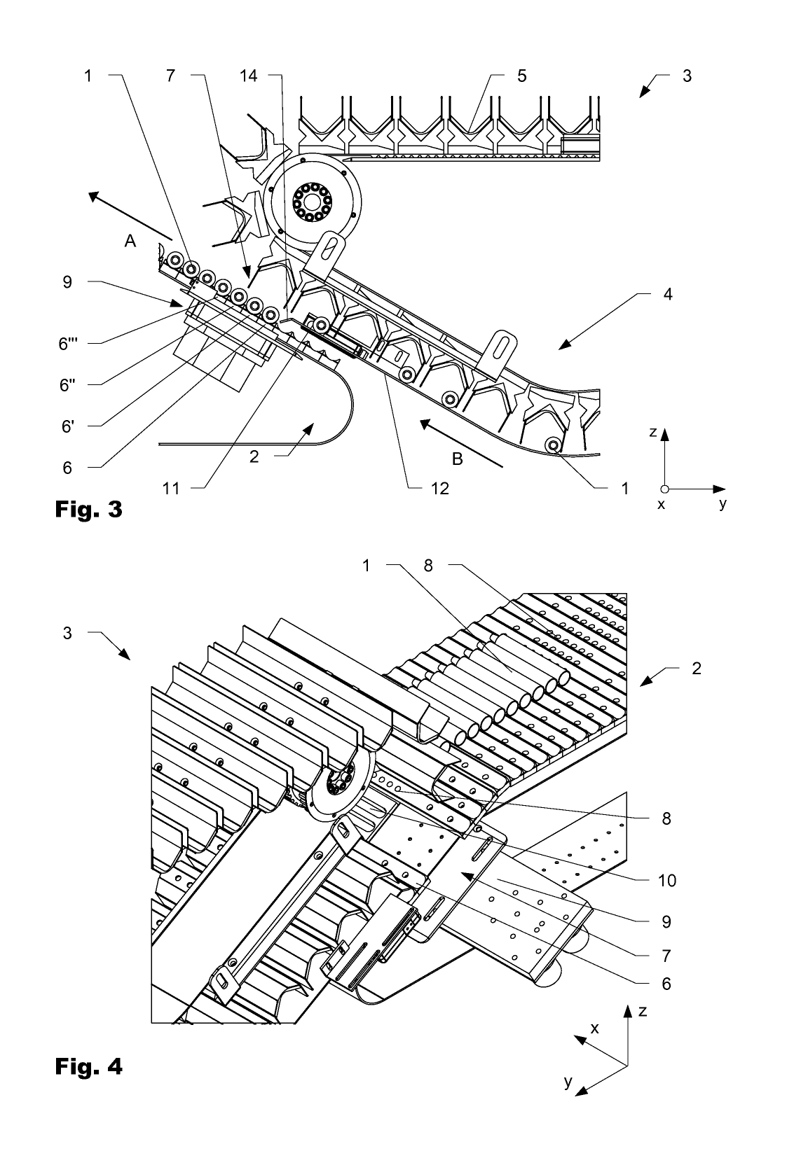

FIGS. 1 and 2 each shows a perspective view of a transfer device for the gapless transfer of elongated, at least approximately hollow cylindrical, product units 1 to a conveyor belt 2. In the transfer device shown, the product units illustrated are empty tubes. FIG. 3 shows a lateral view of the transfer region 7 of the transfer device from FIGS. 1 and 2. The figures are simplified illustrations in which for the sake of clarity certain components have been omitted. Furthermore, in the illustration the conveyor belt 2 and the conveyor chain 4 do not all contain product receiving elements 6 or product receiving containers 5.

The transfer device comprises a supply device 3 with an endless conveyor chain 4 on which, because of the pressure-sensitive tubes, several product receiving containers 5 or product receiving trays are arranged. In this arrangement for each product receiving container a separate product unit is supplied. The product receiving containers 5 are aligned in such a manner that the tubes 1 lie side by side in the longitudinal direction, in respectively adjacent product receiving containers, wherein gaps may occur as a result of eliminated or rejected tubes. Furthermore, the transfer device comprises a conveyor belt 2 with a multitude of product receiving elements 6 for receiving the tubes 1 supplied by the supply device 3.

In the transfer region 7 the conveyor chain 4 and the conveyor belt 2 extend in the same direction of conveyance A, B, gradually rising and parallel to each other at some distance, wherein the conveyor chain 4 is arranged above the conveyor belt 2 so that the tubes 1 can be transferred to the conveyor belt 2 by means of gravity. Below the conveyor chain 4 a product guide, e.g. in the form of a guide plate 12, is provided on which the product unit 1 is conveyed to the transfer region by means of the product receiving container 5. At the end of the guide plate 12 there is a roll-off region 14, e.g. in the form of a roll-off plate, which roll-off region is angled towards the conveyor belt 2. The gradual rise of the conveyor chain 4 or of the guide plate 12, for example at a gradient angle of approximately 30 percent, on the one hand is used for positioning the tube 1 in the product receiving container 5, and on the other hand in this way the trajectory of the tube 1 during transfer to the conveyor belt 2 is shortened. In this manner any positioning errors due to the trajectory are avoided.

In the depicted transfer device the individual product receiving elements 5 are designed so as to be trough-shaped with high walls, thus making it possible to receive product units 1 of different diameters. Prior to the transfer of the tube 1, by means of the rear wall of the product receiving element 5, said tube 1 is conveyed on the guide plate 12 to the transfer region 7. The individual product receiving elements 6 of the conveyor belt 2 comprise a trough-shaped receiving device and are arranged in close proximity side by side so that the product units 1 for the subsequent packaging process are arranged in close proximity side by side on the conveyor belt 2 so as to almost touch each other. These product receiving elements 6 match the particular diameter of the tube 1 to be packed; they are exchanged if the tube diameters change.

Frequently, the tubes are not supplied without any gaps (as shown, for example, in FIG. 3) by the supply device 3, because faulty tubes 1 are rejected prior to transfer, or the product receiving containers 5 of the supply device 3 are not filled without any gaps with the tubes 1 emanating from the production line. For the subsequent packaging of the tubes it is, however, necessary for the tubes to be placed without any gaps on the conveyor belt 2. Furthermore, in particular in the case of lightweight plastic tubes or aluminium tubes transferred at high transfer rates there is the real danger of the tubes 1 jumping from the product receiving elements 6 if placement is too fast, which can result in gaps occurring on the conveyor belt.

This effect can be further amplified in the case of plastic tubes because of electrostatic charges.

In order to ensure a gapless transfer of the tubes 1 from the supply device 3 to the conveyor belt 2 at high transfer rates, the product receiving elements 6 in each case comprise several suction intake openings 8 arranged in the middle of the trough-shaped receiving device. The transfer region 7 is dimensioned such that it extends over several successive product receiving elements 6, 6′, 6″, 6″′. The suction intake openings 8 of the product receiving elements 6, 6′, 6″, 6″′, which suction intake openings 8 are situated in the transfer region 7, are operated with a suction vacuum by means of a suction device 9 so that a transferred tube at its landing is held by suction in the trough-shaped receiving device. On the one hand, this results in a product receiving element 6 that receives the tube 1 always having a suction vacuum, irrespective of the precise positioning in the transfer region, which positioning depends on the supply speed and the trajectory of the tube during transfer. On the other hand, the transfer region 7 is dimensioned with sufficient length so that along a defined transfer path a transferred tube 1 is subjected to suction in the trough-shaped receiving device of the product receiving element 6′, 6″, 6″′ until such time as it has stabilized and several subsequent tubes 1 have been placed. In each individual product receiving element 6 the suction intake openings 8 are arranged in a line of the lowest position.

The transfer device further comprises a transfer control unit (not shown) that is configured in such a manner that it matches the speed of the conveyor belt to the supply speed and to the corresponding trajectory of the tube 1.

In order to detect product gaps in the supply process, the supply device 3 comprises a product unit detector 11 upstream of the transfer region 7, e.g. in the form of an optical sensor. The latter is connected to the transfer control unit. If a gap in the supply is detected, the conveyor belt can be slowed down until the next delivery of a tube 1, or can be stopped in the case of several consecutive gaps.

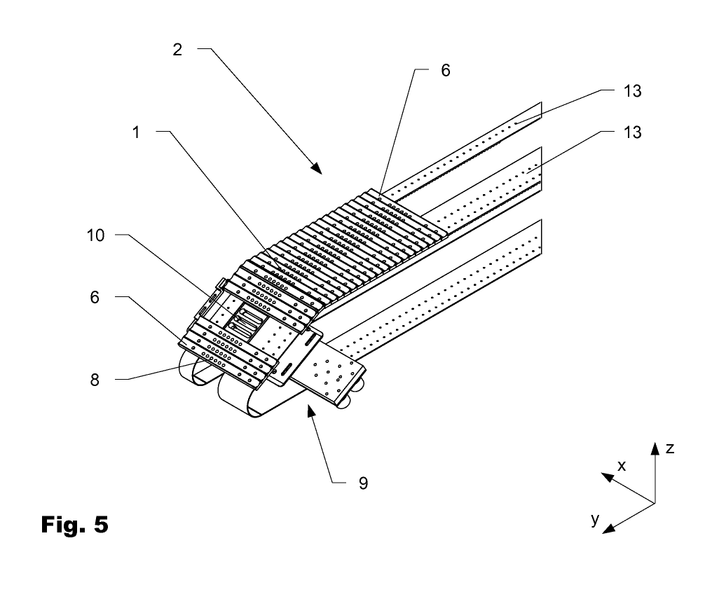

FIGS. 4 and 5 show perspective views of the suction device 9 of the transfer device. Some product receiving containers 5 and product receiving elements 6 have been left out in the illustration. Furthermore, in FIG. 5 the supply device has been left out.

The suction device 9 is arranged in the transfer region 7 underneath the conveyor belt 2; in the embodiment shown it comprises several elongated suction openings 10 that in the transfer region 7 supply a vacuum to the suction intake openings 8 of the product receiving elements 6. In this embodiment the suction openings 10 have been designed and placed in such a manner that a product receiving element 6 moving through the transfer region 7 is continuously subjected to a suction vacuum.

The conveyor belt 2 comprises two endless belts 13, which are spaced apart from each other, to which endless belts 13 the product receiving elements 6 have been attached. In this arrangement the suction intake openings 8 of the product receiving elements 6 are situated above the gap between the two endless belts. The at least one suction opening 10 of the suction device 9 is arranged in the transfer region 7 between the two endless belts 13 of the conveyor belt 2.

### LIST OF REFERENCE CHARACTERS

1 Hollow cylindrical product units/tubes

2 Conveyor belt

3 Supply device

4 Conveyor chain

5 Product receiving container

6 . . . 6″′ Product receiving element

7 Transfer region

8 Suction intake opening

9 Suction device

10 Suction opening

11 Product unit detector

12 Guide plate

13 Endless belt

14 Roll-off region

A Direction of conveyance of the conveyor belt

B Direction of conveyance of the conveyor chain

1. A transfer device for the transfer of elongated, at least approximately hollow cylindrical, product units in the form of thin-walled tubes, to a transport device for supplying a packaging unit with said product units that are arranged side by side without any gaps, the device comprising:
a supply device which conveys at a predetermined speed, for the supply of product units arriving from a production line, and a transport device with a conveyor belt that comprises a multitude of product receiving elements for the onward conveyance of the product units;
wherein the supply device comprises an endless conveyor chain with a multitude of product receiving containers for accommodating individual product units supplied from the production line;
wherein the conveyor chain of the supply device and the conveyor belt of the transport device extend in a transfer region in the same direction of conveyance, gradually rising and parallel to each other at some distance;
and wherein underneath the conveyor chain a product guide is arranged whose one end extends to the transfer region;
wherein
the transfer device further comprises a transfer control unit that is configured in such a manner that it matches the speed of the conveyor belt to a predetermined conveyance speed of the supply device so that a product unit to be transferred, having been delivered at the end of the product guide, lands precisely on the first free product receiving element in the direction of conveyance; and in that
the transfer device further comprises a suction device for producing a suction vacuum, wherein for the transfer of a product unit, which has been supplied by the supply device, to the conveyor belt several product receiving elements that are situated in the transfer region of the transfer device can be operated with the suction vacuum of the suction device so that the product unit to be transferred is held and stabilized in the transfer region in the product receiving element by means of the suction vacuum both during landing and during onwards transfer.

2. The transfer device according to claim 1, further comprising a product unit detector, arranged on the supply device in the direction of conveyance upstream of the transfer region, in order to detect the presence of a product unit in a product receiving container, the product unit detector being connected to the transfer control unit in order to reduce the speed of the conveyor belt in the case of the non-presence of a product unit.

3. The transfer device of claim 1, wherein each of the product receiving elements of the conveyor belt comprises at least one suction intake opening that can be operated with the suction vacuum of the suction device.

4. The transfer device according to claim 3, wherein several suction intake openings are arranged essentially in the middle along the product receiving element.

5. The transfer device of claim 3, wherein the conveyor belt comprises two spaced-apart endless belts to which the product receiving elements are attached, wherein the suction intake openings of the product receiving elements are arranged above the gap between the two endless belts.

6. The transfer device of claim 3, wherein the suction device comprises at least one suction opening arranged in the transfer region, by means of which suction opening the at least one suction intake opening or the several suction intake openings of the product receiving elements situated in the transfer region can be operated with a suction vacuum.

7. The transfer device according to claim 6, wherein the at least one suction opening of the suction device is arranged in the transfer region between the two endless belts of the conveyor belt.
